(19) United States
(12) Patent Application Publication
(10) Pub. No.: US 2004/0225558 A1
(43) Pub. Date: Nov. 11, 2004

(54) Generating revenue through use of an interactive computer system

(76) Inventor: Quinn H. Lipin, Newton, MA (US)

Correspondence Address: Quinn Lipin, Net-U-Net, L.L.C., 16B Upham Street, Newton, MA, 02494, US

(21) Appl. No.: 09/779,538

(22) Filed: Feb. 9, 2001

Related U.S. Application Data
(60) Provisional application No. 60/182,933, filed on Feb. 16, 2000.

(51) Int. Cl. G06F 17/60

(52) U.S. Cl. 705/14

(57) ABSTRACT

An interactive computer system that identifies Customers when the Customer selects a display that appears on an Affiliate site. The system connects the Customer to the selected Merchant site and to the Clearinghouse site which frames the Customer's view. The Frame lists other network sites that are selected by the Clearinghouse site as of possible interest to the Customer. Sales revenue is generated for a Merchant and commission revenue is generated for the referring Affiliate based on purchases by an end user Customer during the initial and subsequent visits to the Clearinghouse site.

### FIELD OF THE INVENTION

The present invention relates in general terms to a data processing system that encourages electronic commerce by providing a Customer that selects an offering by a particular Merchant with other related sites on the network and enables immediate transport to those sites on a Frame that appears with the Merchant site.

### BACKGROUND

This invention relates to techniques for generating revenue through use of an interactive computer system.

Recently, networks of interconnected computers, such as the Internet, have provided a convenient framework for obtaining information and transacting business. The World Wide Web (the Web), which is a collection of interconnected computers that forms a subset of the Internet, allows users to navigate areas of interest. Information is made available by accessing a site on the Web using, for example, a personal computer with an application program known as a browser. Information from the introductory page, or home page, of a particular site is linked to other pages that can be accessed, for example, through hyperlinks that may appear as a word or a graphic image on one Web site. Additional hyperlinks allow a user to be connected to other Web sites.

The Internet has become an important vehicle of commerce by providing consumers with easy access to a wealth of information about the goods and services that merchants provide and by facilitating transactions regarding such goods and services. To expand users' knowledge and awareness of various merchants on the Web, the use of banner advertisements has become common at some popular sites. The banners combine graphics and text to provide an appealing display to encourage user interest. By clicking on the banner, the merchant Web site associated with the banner appears on the user's computer screen. The user then can obtain information about the goods and/or services provided by the merchant and can place an order for those goods and/or services through an on-line transaction. Commerce generated by the banner or similar promotional links have become increasingly important in allowing merchants to transact business over the Internet.

### BRIEF DESCRIPTION OF THE DRAWINGS

FIG. 1 illustrates an exemplary interactive computer network.

FIG. 2 shows a computer network supporting service on the World Wide Web.

FIG. 3 illustrates exemplary relationships among various Internet sites including a merchant-affiliate network.

FIG. 4 illustrates exemplary user traffic flow in the merchant-affiliate network.

FIG. 5 illustrates an exemplary affiliate Internet site.

FIG. 6 illustrates an exemplary framed merchant Internet site.

FIG. 7 illustrates an exemplary framed page of a primary site.

FIG. 8 illustrates an exemplary home page of the primary site.

FIG. 9 illustrates another example of user traffic flow in the merchant-affiliate network.

FIG. 10 is a flow chart illustrating how various user activities can be tracked in the merchant-affiliate network.

### DETAILED DESCRIPTION

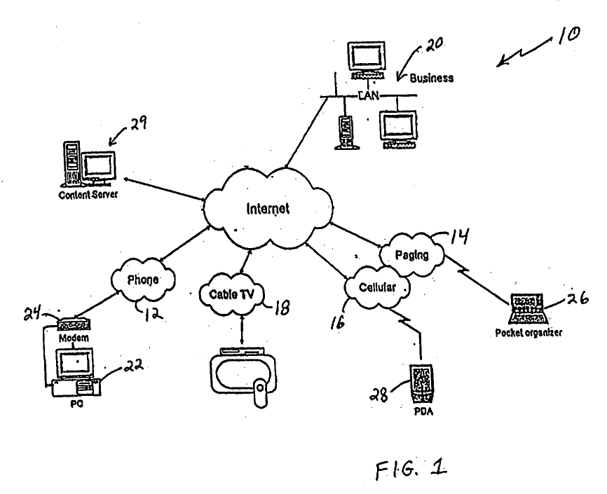

As shown in FIG. 1, an exemplary interactive computer network 10, such as the Internet, includes interconnected computers that support communications among different types of users. Such users can include, for example, businesses, individuals, universities and financial institutions, among others. The network 10 can support various types of communication links, such as telephone 12, paging 14, cellular 16 and cable television 18 links. Terminal equipment used with the network 10 can include, for example, local area networks (LANs) 20, personal computers 22 with modems 24, pocket organizers 26, personal data assistants (PDAs) 28, and content servers 29 of multi-media, audio, video and other information.

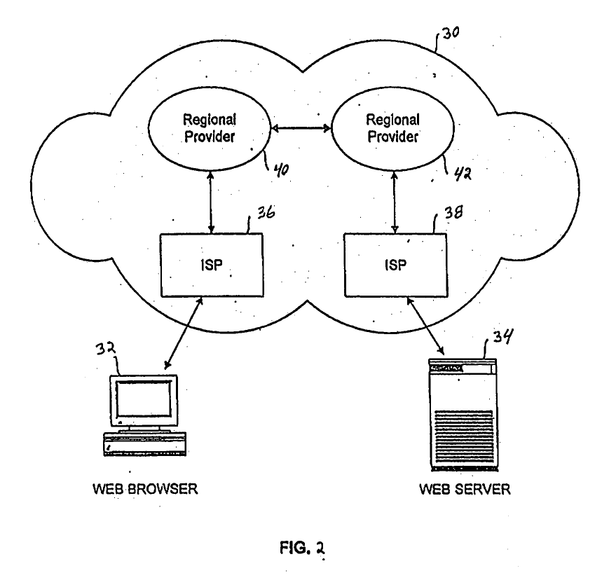

As shown in FIG. 2, an exemplary Internet network 30 supports Web service. A Web browser 32 is connected through the network 30 to a Web server 34 that can be implemented, for example, as a computer and that provides content, such as images, text, video, sound and Java applets, to users. An Internet Service Provider (ISP) 36 links the browser 32 to the network 30, and an ISP 38 links the server 34 to the network. Regional service providers 40, 42 and other intermediaries route traffic between the ISPs 36, 38.

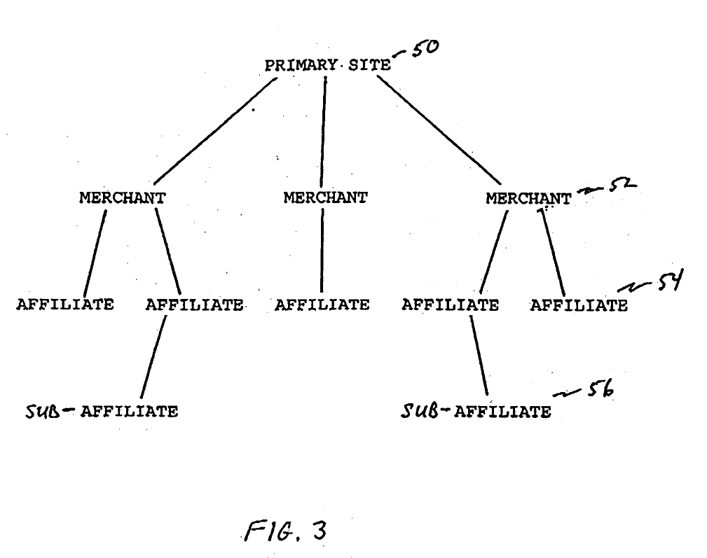

The techniques described below allow revenue to be generated by encouraging and maintaining Internet traffic in a merchant-affiliate network. Each site in the merchant-affiliate network has a defined relationship with other sites in the network. FIG. 3 illustrates an exemplary relationship among Internet sites including a primary site 50 that serves as a portal to provide search capabilities and to enable Web browsers to access content services. A merchant-affiliate network includes one or more merchant sites 52 and one or more affiliate sites 54. The network also may include one or more sub-affiliate sites 56 each of which is associated with an affiliate site. Each sub-affiliate 56 serves a dual role as both an affiliate and a sub-affiliate.

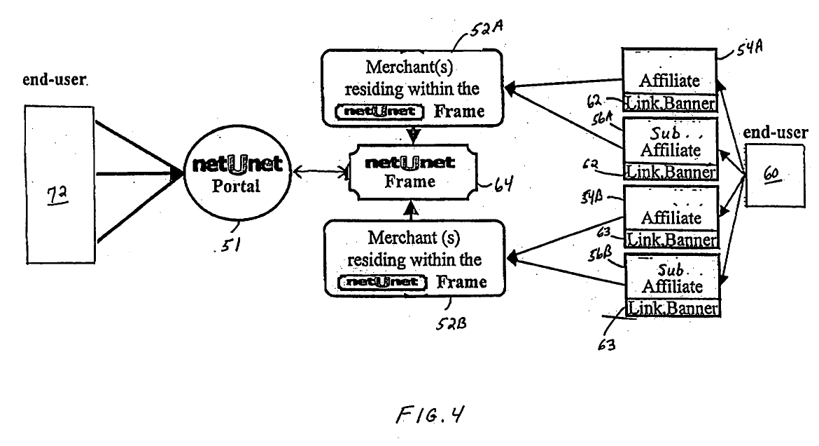

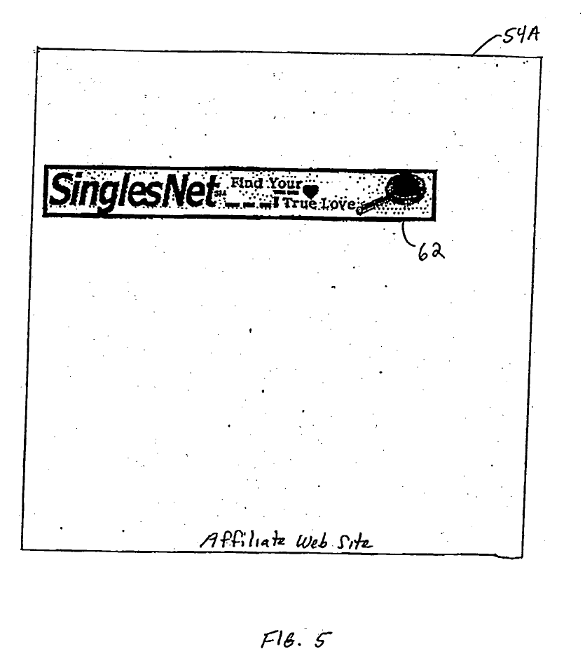

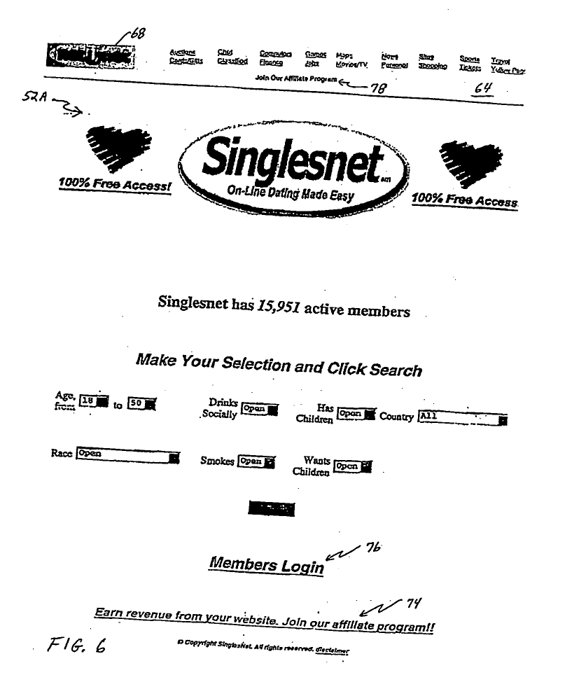

In general, each affiliate site 54 hosts a merchant banner that provides a link to an associated merchant's site as well as to the primary site 50. For example, as shown in FIGS. 4 and 5, a user 60 may access an affiliate site 54A that includes a banner 62 associated with a particular merchant. By clicking on the banner 62, a browser on the user's personal computer accesses both the primary site 50 and the merchant's site 52A (typically identified in the banner). The browser transports the user simultaneously to both the merchant site 52A and the primary site 50. Using a technique known as framing, both the primary site 50 and the merchant's site 52A are displayed on the user's computer screen. As illustrated in FIG. 6, the merchant's Web site 52A appears in the lower portion of the screen and is framed by the primary site 50 which appears in the frame 64 at the top of the screen. The frame 64 serves as a gateway to the portal 51 (FIG. 4) and lists multiple categories that may be of interest to the user. For example, as shown in FIG. 6, the frame 64 displays various links, such as Auctions, Computers, and Travel, among others.

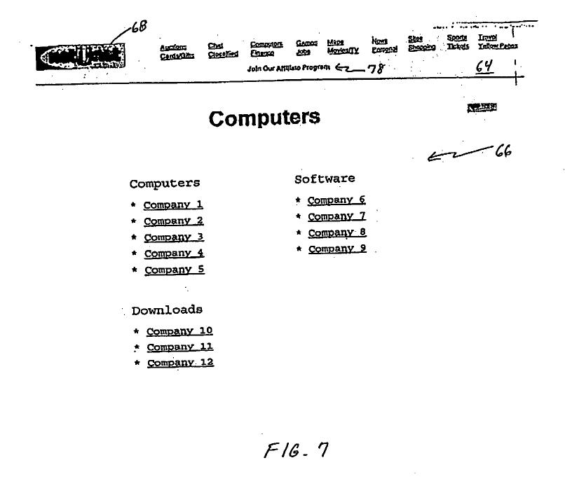

The user 60 can choose to browse the merchant's site 52A and can complete one or more transactions for goods and/or services provided by the merchant. The user 60 also can select one of the categories that appear in the frame 64 by clicking on the corresponding link to access other sites through the portal 51. For example, if the user 60 clicks on the link identified as Computers, a list of merchants providing goods and/or services related to computers would appear in the lower portion 66 of the user's computer screen as shown in FIG. 7. The links in the frame 64 remain displayed on the user's screen so that the user still can access any of the listed categories. The user 60 can choose to click on one of the listed merchants to access that merchant's Web site. The merchant's Web site then would appear in the lower portion of the screen, while the list of categories in the frame 64 also remains displayed at the top of the screen. The user 60 can browse the merchant site and can complete one or more transactions. As before, the user 60 still has the option of accessing other sites through the portal 51 by clicking on one of the links in the frame 64.

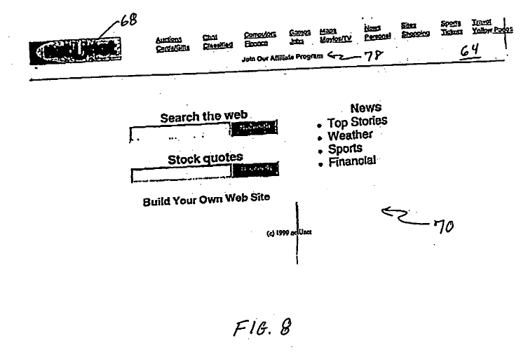

The user 60 also can access the home page of the primary site 50 by clicking on a banner or other link 68 in the frame 64. If the user clicks on the link 68, the home page 70 of the primary site 50 appears in the lower portion of the screen, as shown in FIG. 8. The home page 70 allows the user 60 to search the Web for particular information by entering one or more search terms. The primary site includes a search engine for that purpose. The user also may access news and other content from the home page via links that appear on the user's screen. When the home page 70 is displayed, the frame 64 also appears in the upper portion of the user's screen.

Returning to FIG. 4, the user's browser also can access both a merchant site 52 and the primary site 50 through a sub-affiliate site, such as the sub-affiliate site 56A. For example, if the user 60 clicks on a banner associated with the merchant 52A while visiting the sub-affiliate site 56A, the browser transports the user simultaneously to both the merchant site 52A and the primary site 50 as described above.

Alternatively, if the user 60 were to click on a banner 63 associated with another merchant 52B while visiting an affiliate site 54B or a sub-affiliate site 56B, the browser would transport the user simultaneously to both the merchant site 52B and the primary site 50.

As is evident from the foregoing discussion, a user can enter one or more merchant Web sites 52 through an affiliate site 54 or a sub-affiliate site 56. Specifically, as the user navigates within a particular merchant Web site, the frame 64 remains displayed on the user's screen so that the user can access other Web sites via the portal 51 by clicking on any of the displayed links.

As indicated by FIG. 4, a user 72 also can access the home page 70 of the primary site 50 directly. In that case, the user's screen would appear as in FIG. 8, with the home page 70 in the lower portion of the screen and the frame 64 in the upper portion.

As described below, when a user enters an affiliate site 54 that has a banner for a particular merchant site, revenue can be generated for that affiliate based on the user's activity with respect to the particular merchant site as well as the user's activity with respect to other merchant sites visited as a result of clicking on the banner and subsequently clicking on links in the frame 64. Therefore, an affiliate can obtain revenue streams from multiple merchant sites even though the affiliate's site may display a banner for only one particular merchant site.

Various types of revenue can be generated for affiliate sites 54 and for the primary site 50 based on tracking various Web-user activities: (1) impression revenue, in other words, revenue that is generated based on a user's viewing a merchant's banner 62 when the user visits an affiliate site 54; (2) revenue based on the number of hits, in other words, revenue that is generated based on a user's visiting a merchant site 52 by clicking on a banner 62 in an affiliate site 54 or clicking on a link accessed through the portal 51; and (3) transaction revenue, based on revenue that is generated as a result of completed transactions with one or more merchant sites 52.

In general, each merchant site 52 establishes its own revenue program for affiliate sites 54. For example, one merchant site may agree to pay affiliates a fixed percentage of completed transactions, whereas another merchant may agree to pay a fixed amount of money for each hit to its site. A third merchant might agree to pay a fixed sum of money for each time a user views a site that includes a banner or link to the merchant's site. Revenue that a particular merchant has agreed to pay to affiliates is paid to the affiliate site 54 through which the user entered the merchant-affiliate network.

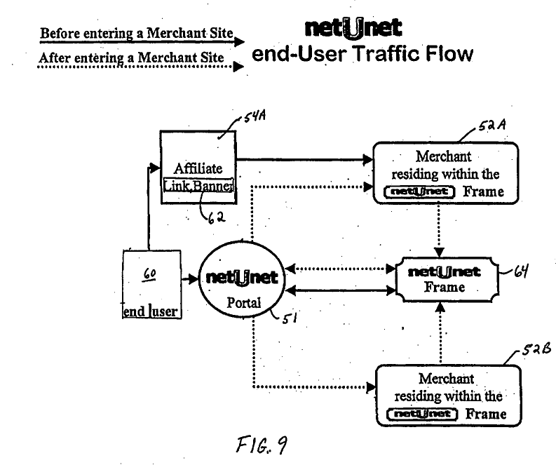

FIG. 9 illustrates an example of how an affiliate, such as the affiliate 54A, can obtain revenue streams from multiple merchant sites, such as the merchant sites 52A and 52B. In this example, it is assumed that the merchant site 52A pays affiliates a fixed amount for each hit, and that the merchant site 52B only pays affiliates a fixed percentage of the monies it receives for each completed transaction. For the purpose of illustration, it is further assumed that a user 60 visits the affiliate site 54A and clicks on the banner 62 associated with the merchant site 52A. The user's browser accesses the merchant site 52A as described above. That activity constitutes a hit for which the merchant site 52A has agreed to pay the affiliate 54A regardless of whether the user completes a transaction at the merchant site. After visiting the merchant site 52A the user 60 can access the portal 51 through the frame 64 that appears on its screen (see, for example, FIG. 6). From the portal 51, the user may access the merchant site 52B and complete a transaction, for example, by purchasing goods while visiting the merchant site. The completed transaction constitutes an activity for which the merchant site 52B has agreed to pay the affiliate 54A. After completing the transaction at the merchant site 52B, the user 60 can choose to exit the Internet or visit other sites through the portal 51. In general, the frame 64 will continue to appear on the user's computer screen until he leaves the browser, and revenue can continue to be generated on behalf of the affiliate 54A until he leaves the browser or until he exits and later re-enters the merchant-affiliate network through netUnet.com.

Revenue also is generated for the owner of the primary site 50. The primary site 50 receives from each merchant 52 a fixed percentage of the amounts paid by the merchant to affiliates 54. The fixed amounts can vary from one merchant to another depending on the basis of the merchant's payment to affiliate sites. For example, a merchant that pays affiliates a fixed amount for each hit could pay the primary site 50 two percent of the amount paid to the affiliates, whereas a merchant that pays affiliates a fixed percentage of gross revenues would pay the primary site only one percent of the amount paid to the affiliates. The primary site also can obtain impression revenue by displaying merchants' advertising banners through the portal 51. Each time a user views a merchant's banner through the portal 51, the merchant would pay a fixed amount to the primary site. Similarly, a user's clicking on a merchant's banner or completing a transaction with the merchant are recognized as events that can generate revenue for the primary site if the merchant's affiliate program is based on impression revenue.

The server associated with the primary site 50 tracks the number of times a user views a banner or link to a merchant's site, the number of hits to each merchant's site, and the value of transactions completed at each merchant site. The server associated with the primary site also tracks the affiliate site through which the user entered the merchant-affiliate network. In that way, each revenue-generating activity can be associated with the appropriate affiliate site. For example, when a user accesses an affiliate's site 54, the server associated with the primary site 50 pulls up a particular merchant's banner, and the server records that event as an impression. Similarly, if the user clicks on the merchant's banner and is transported to the merchant's Web site, the server records the event as a hit.

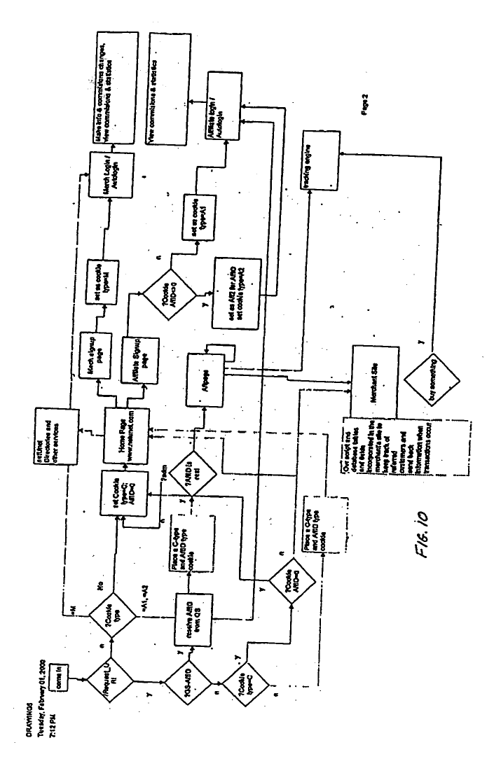

To assist the server associated with the primary site 50 in keeping track of completed transactions, cookies can be used (see FIG. 10). Cookies are pieces of data placed, for example, in the user's browser by a server associated with the primary site 50. Each cookie stores various information including codes that allow the server associated with the primary site 50 to identify the affiliate site through which the user obtained access to the merchant-affiliate network. The cookie is lodged in the user's browser when the user clicks on a merchant's banner while visiting an affiliate Web site 54. When a user completes a transaction at a merchant site 52, the cookie is stored in the merchant's transaction server. Information stored in the merchant's transaction server is uploaded to the primary site's server on a periodic basis, for example, at the end of each day. Alternatively, the merchant's transaction server can include a script that captures the cookie and uploads it to the primary site's server immediately. The value of the transaction, as well as the time, date and nature of the transaction, also can be uploaded to the primary site's server.

Similarly, when a user travels through the portal 51 and clicks on a link within the portal, the primary site's server captures the cookie and reports the event as a hit.

The system encourages Web site owners to become affiliates. For example, a user visiting a merchant site 52A can click on a link 74 (FIG. 6) to join the merchant's affiliate program. Similarly, a user can click on a link 78 (FIG. 6) appearing in the frame 64 to join an affiliate program. If a cookie previously was stored in the user's browser, then the user is directed to a registration page allowing the user join the affiliate program of the merchant associated with the affiliate site identified by the cookie. Furthermore, the new affiliate becomes a sub-affiliate of the affiliate identified by the cookie. If a cookie identifying an affiliate site was not previously stored in the user's browser, the user is directed to a general registration page for new affiliates. In that case, the new affiliate is not considered a sub-affiliate because it did not become a member of the affiliate program by visiting an existing affiliate Web site. In addition, members of an affiliate program can login using a link 76 (FIG. 6) to view the details of affiliate programs run by other merchants.

A sub-affiliate is treated like an affiliate with respect to revenue payments by the merchants. However, an affiliate also can receive revenue when a user accesses the merchant-affiliate network through a sub-affiliate. Each merchant can establish its own program according to which affiliates receive revenue based on the revenue received by its sub-affiliates.

For example, in one scenario, it is assumed that a merchant pays affiliates 10% of gross sales based on completed transactions and also pays an affiliate 30% of the revenues paid to that affiliate's sub-affiliates. It is further assumed that the merchant pays the primary site a fixed percentage of, for example, 1% of its gross sales achieved as a result of users accessing the merchant-affiliate network. If a particular merchant has gross sales of $1,000 as a result of one or more users accessing the merchant site via a particular sub-affiliate, then the sub-affiliate would receive 10% of $1,000, in other words $100, from the merchant. In addition, the affiliate associated with the sub-affiliate would receive 30% of $100, in order words $30, from the merchant. Furthermore, the primary site would receive 1% of the gross sales, in other words $10.

In another scenario, it is assumed that a merchant pays affiliates $0.01 for every hit to its site that occurs as a result of users accessing the merchant-affiliate network. The merchant also pays an affiliate 50% of the revenues paid to sub-affiliates associated with the affiliate. It is further assumed that the merchant pays the primary site a fixed percentage of 2% of the amounts paid to the affiliates (and sub-affiliates). If a particular merchant has 10,000 hits to its site as a result of one or more users accessing the merchant site through a particular sub-affiliate, then the sub-affiliate would receive $100 from the merchant. In addition, the affiliate associated with the sub-affiliate would receive 50% of $100, in other words $50, from the merchant. Furthermore, the primary site would receive 2% of $150, in order words, $3.

As previously mentioned, the primary site 50 uses a search engine that allows users to perform on-line searches (see FIG. 8). In one implementation, new affiliates automatically are placed within the search engine. Affiliates can be ranked based on the amount of user traffic they generate for the merchants. For example, an affiliate that generates a large amount of traffic can be placed in a higher ranking within the response to a search. Affiliates that fail to generate traffic during a particular time frame can be removed at least temporarily from the search engine.

The placement of merchant links within the portal 51 can be based on the revenues paid by each merchant during a particular time frame. For example, merchants paying greater revenues to affiliates during a particular month would be ranked higher on the list of merchants appearing on a page of the portal 51 (see, for example, FIG. 7). In one implementation, merchants that base their affiliate programs on impression revenue would not be listed.

Other implementations are within the scope of the invention.

What is claimed is:

1. In a network of interconnected computers for establishing, managing and tracking commercial transactions, comprising of:
a. Customers interconnected to said network;
b. Affiliate sites interconnected to said network and programmed to display to a Customer visiting the Affiliate site information and linking instructions about one or more products or services available for commercial transactions with a Merchant or Merchants;
c. Clearinghouse site interconnected to said network and programmed to receive information regarding display of or selection of said display information on the Affiliate site, and the ability to read the Customer's unique identification code, and store said code in memory, and further to provide connection of said Customer to an identified Merchant site;
d. Clearinghouse site also sends information and programming to the Customer site so that superimposed upon part of the Merchant's site the Customer sees other information within a Frame as chosen by the Clearinghouse;
e. Customer may by choosing an information display on the Frame be transported to another Merchant site, another non-Merchant site, a Clearinghouse maintained search engine or listing of other sites that may be of interest to the Customer.
wherein the Clearinghouse stores and maintains the Customer's identification code, tracks transactions the Customer makes with any Merchant that is a member of the network.

2. The system of claim 1 wherein a single Affiliate may receive credit from multiple Merchants arising from transactions from initial and subsequent visits by the Customer to the Clearinghouse.

3. The system of claim 1 wherein a Customer that visits an Affiliate site, and selects a Merchant display, is transported both to the Merchant's site and a Frame with additional information of possible interest to the Customer.
